(19) United States
(12) Patent Application Publication
(10) Pub. No.: US 2004/0225589 A1
(43) Pub. Date: Nov. 11, 2004

(54) Shari'ah (Islamic) compliant computer-based inter-institutional/inter-bank network

(76) Inventor: Joanne Marlowe-Noren, Wadsworth, IL (US)

Correspondence Address: Paul E. Schaafsma, Suite 221, 521 West Superior, Chicago, IL, 60610, US

(21) Appl. No.: 10/860,184

(22) Filed: Jun. 3, 2004

Related U.S. Application Data
(63) Continuation-in-part of application No. 10/295,087, filed on Nov. 15, 2002.

(51) Int. Cl. G06F 17/60

(52) U.S. Cl. 705/35; 705/36; 705/37

(57) ABSTRACT

An inter-bank/inter-institutional financial network formulated in accordance with the principles of the present invention supports the implementation of certain Shari'ah (Islamic) compliant financial products. A standardized, Shari'ah (Islamic) compliant financial instrument is created which is conducive to trading and which has comparable characteristics to those traded on the conventional markets. An inter-bank/inter-institutional financial alliance is formed under which the participants in the network play multiple and varied financial roles in select financial offerings prior to taking an investment offering to the Islamic investment marketplace for placement. In particular, each participating institution in the inter-bank/inter-institutional financial alliance agrees to support the position of another participating institution as may be required under a contingent guarantee of repurchase in support of such other participating financial institution's issuance of financial instruments. Further, the guarantee is agreed for issuance within a Shari'ah compliant operational framework which does not allow for the acceptance of consideration or specific security/collateral against the issuance of a guarantee, thus enabling the deployment of a financial mechanism having a financial impact similar to a conventional securitization or financial enhancement that would otherwise be disallowed under Shari'ah financial guidelines. Thus, when the financial instrument is issued, it is underwritten for repurchase via a syndication amongst the inter-bank/inter-institutional financial participants via their respective issuance of their repurchase guarantee which are callable on a contingent basis. The issuer also acts as repurchase guarantor on a contingent basis on behalf of another bank in the inter-bank alliance as issuer of their respective financial instruments.

### RELATED APPLICATION

This application is a continuation-in-part of U.S. patent application Ser. No. 10/295,087 titled “INVESTMENT GRADE SHARI'AH (ISLAMIC) COMPLIANT FINANCIAL PRODUCT” filed on 15 Nov. 2002.

### FIELD OF THE INVENTION

The present invention relates to an inter-institutional/inter-bank networked methodology in support of the implementation of certain Shari'ah (Islamic) compliant financial products.

### BACKGROUND OF THE INVENTION

Historically, the Islamic versus non-Islamic investment philosophies have operated as wholly independent and virtually unrelated investment and finance systems for hundreds if not thousand of years. In Islamic economies, Shari'ah investment principles and religious guidelines are applied and practiced which are clearly understood by Islamic institutions and practicing Muslims. Shari'ah investment principles and religious guidelines refer to Islamic law related to financial and investment matters within the Islamic or Muslim community. Thus, Islamic economies have grown in strength by supporting Islamic projects and investments within the global Islamic community. Likewise, the investment banking, venture capital, and capital markets of the non-Islamic West have been well served by operating solidly and consistently within their own respective financial markets. These western financial markets have grown into a globally dominant force in respect of both financial strength and investment market volumes, making them the “convention” or standard in capital markets procedures and practices around the globe.

However, the Islamic marketplace has extraordinary depth and financial resources which, when tapped, will create an equally formidable economic presence in the global marketplace. In looking at the conventional markets versus Islamic investment, banking and financial services markets, there are a number of key contributing factors as to why the Islamic markets have remained somewhat segregated from the rest of the global capital markets. First and foremost, the Islamic investment community is subject to a foundational investment component which requires each investment undertaken to be of a Shari'ah compliant nature. Second, there is no established centralized system for Islamic banking practices such that the banks and institutions capable of working together on a financial platform can do so efficiently on a cross-border basis. Third, because there is no significant financial interplay amongst the Islamic banks and institutions, there has been little motivation for institutions to participate in various reporting and financial rating systems that have been attempted over the years. Finally, the Islamic market is in need of a fully functional financial exchange which will aid in the freer flow of capital between institutions and investments, thereby bettering market performance and investor liquidity.

Initially, the governing factor of Islamic investment which forms the basis for what differentiates Islamic investment practices from conventional practices is the requirement to undertake or engage in investments which comply with Shari'ah investment principles, guidelines and law.

Historically, these investments have required a very active participation by the Islamic investor; the luxury of passively acquiring an investment as is the norm in the conventional institutional markets has not been an option to the high-volume Islamic institutional investor that seeks to comply with Shari'ah investment principles. Islamic investment opportunities have been and still are managed using a very “hands-on” investment philosophy. Further, while a “hands-on” investment philosophy can produce an attractive yield to the investor, the absence of passivity in funds management customarily comes with a high price. This high price makes such a passive philosophy untenable and largely impracticable for a sophisticated volume investor. Thus, Islamic investment in large part calls for a project-by-project review of each and every investment against a backdrop of a traditional private placement.

Although some degree of investment passivity has been afforded to the smaller-scale Islamic investor through the application of certain Islamic/Shari'ah compliant investment account structures, these do not represent a viable wholesale/volume investment management tool. Specifically, Islamic banking and financial institutions have a variety of retail account structures available to their customers. For example, one such retail account structures consists of savings accounts which pay a small premium, or hiba, at the discretion of the bank. A further example consist of investment accounts which require a longer deposit/investment duration and are managed at the complete discretion of the bank or financial institution; similarly to becoming an equity stake holder, however, these accounts subject the investor to a loss of some or all of its finds. A still further example consists of special investment accounts which operate similarly to an investment account, but permit the investor to take direction from the bank or financial institution and implement their investment in a specific or recommended project directly. None of these passive investment structures assure the investor of any minimum yield or the preservation of its investment amount. The investor, in order to best preserve its position and increase its chances of reward, must maintain a much more active role in management. Therefore, in order to achieve stronger market returns, the Islamic investment community has generally been forced to maintain a very active hand in the structuring of its investment portfolios—a practice which is both time-consuming and expensive.

Only recently in response to the need to develop a passive investment grade investment vehicle has a financial technology in the form of a new type of Shari'ah compliant investment unit has been proposed for implementation in the Islamic marketplace (U.S. patent application Ser. No. 10/295,087 titled “Investment Grade Shari'ah (Islamic) Compliant Financial Products” filed 15 Nov. 2002, the disclosure of which is incorporated herein by this reference). This financial instrument (the “Investment Unit”) is conducive to high-volume investment using a standardized format which remains consistent in form regardless of the underlying investment strategy or use of proceeds. Thus, the Investment Unit creates a standardized template for institutional investment that for the first time produces an investment dynamic in which the Investment Unit characteristics take precedent over the underlying use of investment proceeds derived there from. The Investment Unit is able to become the focal point of an investment activity amid a back drop of cross-institutional financial guarantees and banking alliances which stand to be the fundamental “tie that binds” among previously disassociated Islamic financial institutions. Such a framework aids the investor in relying upon the maintenance of a minimum investment value over the term of the Investment Units purchased while still providing the opportunity for yield to be generated based upon the underlying successful deployment of proceeds of the investment. Thus, investor passivity may be fostered via these Investment Units.

The widespread commercialization of this Investment Unit or investment units comparable thereto calls for the implementation of a networked infrastructure among the Islamic banks and participating financial institutions. This networked infrastructure would serve as the basis to act in support of greater liquidity, investment returns, and profit opportunities. It is this coordinated inter-institutional/inter-bank dynamic (when used herein the term “inter-bank” will refer to any inter-related financial institution regardless of whether such institution is licensed or operating as a bank or not) which has yet to be achieved within the context of the present-day Islamic marketplace.

By contrast, in the conventional markets, there are a number of strong, performing investment vehicles that can be easily defined and absorbed by the market without need for new, investment-specific financial systems support. Because of its long history of institutional network infrastructures, the conventional markets are conducive to the creation and absorption of new municipal and corporate bond products, the issuance of collateralized notes, debentures, Variable Rate Demand Notes, Treasury Notes and Bonds, etc.

However, the vast majority of such investment vehicles do not comply with Shari'ah guidelines and are therefore disqualified from purchase by an individual, institution or entity which subscribes and abides by Islamic investment principles. Moreover, many of the conventional market systems that enable the administration and active trading of these types of instruments such as certain inter-bank clearing methodologies, inter-bank lending systems and practices, institutional credit rating frameworks, and financial reporting systems are not yet widely available—or for that matter, available at all—within the Shari'ah compliant environment. It is these networked systems that aid in the cultivation of the critical component of investment and investor liquidity in the conventional marketplace. It is this infrastructure which lubricates any conventional market mechanisms in order to produce efficiencies.

In order for the Islamic capital market to develop sophisticated services to cater to its Shari'ah compliant investor base, not only does the Islamic financial market need to create and adopt new types of passive investment instruments, but it needs to develop the administrative infrastructure to permit the use of those investment instruments within the context of a fluid Islamic capital market. This administrative infrastructure needs to be developed as a networked and coordinated computer-based banking and institutional investment system.

Second, the Islamic investment and banking system is unique in that regulation is on the basis of religious and philosophical interpretations of the Holy Q'uran. A core central system in support of the administration of the global Islamic financial market spanning many governmental and geographic areas needs to have the flexibility to be deployed on a cross-border basis. At the present, there are supervisory institutions in place for monitoring policy and providing guidance as to interpretation of Shari'ah law by banking, financial institutions, and financial service providers on a global basis—such as the Islamic Financial Services Board (“IFSB”) and the Accounting and Auditing Organization for Islamic Financial Institutions (“AAOIFI”). However, a computer-based clearing and communications system for the Islamic financial market has yet to be developed. This type of inter-bank system is critical to leveling the proverbial “playing field” between conventional market practices which are conducive to inter-bank lending, instrument trading, financial underwriting, and expedited international investment transactions and the Islamic financial world.

In short, due to key Islamic principles that have been extrapolated into investment principles constituting Shari'ah investment guidelines, many of the day-to-day financial practices of financial institutions that the conventional markets take for granted—such as inter-bank lending practices, for example—are not available for use by Islamic financial institutions under Shari'ah law. This can place extraordinarily strong and well-capitalized Islamic financial institutions at a disadvantage in conducting business amongst themselves and increases the inefficiencies involved with conducting “everyday business” as viewed by conventional markets.

More particularly, under present circumstances Islamic institutional participation in volume investments is ridded with liquidity considerations and Shari'ah compliance underwriting procedures. This results in causing any attempt at volume deployment of capital to be a potentially arduous process. For example, the placement of a Shari'ah compliant investment product by a participating institution lacks standardized or specific offering procedures or structures that can greatly increase market inefficiency in preparing an offering for market. In addition, there is no capacity for short-term inter-institutional lending or credit practices which can aid in shoring up short-term liquidity needs of one institution with the available assets of another. Also, there is no organized means of remarketing an investment expeditiously to another equally qualified investment institution since investment formats and forms of investment instruments vary greatly amongst themselves. Further, there is no inter-institutional, standardized messaging and communications system specifically tailored to the needs of the Islamic institutional financial market such that Shari'ah compliant financial mechanisms and processes can be efficiently deployed.

The building of a banking and financial communications system modeled to address the special needs of the Islamic investment and financial community will enable qualified Islamic financial institutions to work together freely, with full reliance on the qualifications and quality of the other participating institutions. In addition, a banking and financial communications system based upon a universal platform of processes and functions will result in a rise in market efficiencies. Moreover, such a system stands to become a practical extension for the active deployment of the supervisory standards and policies of applicable Shari'ah compliance regulatory bodies and governmental agencies such as but not necessarily limited to the IFSB and AAOIFI.

The third factor in advancing the development of an inter-bank system within the Islamic financial market is the need for the creation of a platform under which Islamic financial institutions may be measured and rated in accordance with internationally accepted standards and practices. Historically, there has been little or no significant benefit to individual institutions in the form of financial interplay amongst Islamic banks and institutions or between Islamic institutions and conventional institutions to inspire Islamic institutions to tender the necessary financial disclosures to fuel such a system. Thus, there has been little motivation for Islamic institutions to undergo the rigors of participating in reporting frameworks and financial rating systems that have been proposed in various forms over the years. However, in today's global economy more than ever, providence of funds or funds origin is a critical matter that must be addressed in order to assure continuing, unfettered investment operations. Such matters of providence and origin can only be addressed successfully via consistently structured financial disclosures.

When attempting to inspire financial disclosure, the potential benefits of making requested disclosures are weighed by the disclosing entity against possible risks of having those disclosed facts available to competition or otherwise detrimentally applied. Aside from evidencing good providence of investment funds, there has been little in the way of mitigating factors or benefits to tip the scales in favour of extensive disclosures by Islamic institutions, even though such would aid in weighing the performance and strength of an Islamic institution in a manner comparable to standards thus far reserved for conventional financial institutions. As it stands today, Islamic financial institutions have very few good reasons to participate in reporting and disclosure requests consistent with conventional market norms; thus, if Islamic institutions are to actively participate, the benefits of participation must be clear-cut and unambiguous.

Beyond financial motivations, ease in furnishing reporting data or otherwise filing disclosures is a critical factor to the successful adoption of desired reporting practices by Islamic institutions. Moreover, when it comes to furthering the interests of Islamic institutions, reporting standards pertaining to Islamic institutions should go beyond basic financial models to include Shari'ah compliance reporting. In addition, these reporting standards should provide for a rating standard to be developed that accounts not only for financial standing but also for standing as to Shari'ah compliance performance. Presently, there has not been a reporting system successfully and widely deployed that inspired consistent participation as to matters of financial performance and Shari'ah compliance by Islamic financial institutions. Until such a system exists, the Islamic financial market will remain for the most part fundamentally incompatible with investment practices within the framework of the conventional markets. Likewise, the Islamic financial market will likely remain unable or unwilling to coordinate financial interests and objectives amongst themselves within an inter-bank networked philosophy.

Lastly, at this pivotal period in the development of the Islamic financial market, the Islamic investment theatre remains fragmented in approaching the creation of a true Islamic financial exchange. To date, there has not yet been a system introduced to address the needs of the Islamic banking and financial institutions directly as to the creation of a ready-made electronic marketplace for their own financial instrument issuances, a forum for resale of existing issuances on a wholesale or retail basis, and the cultivation of qualified subject investments for subsequent investment.

The evolution of such an exchange should stem from the interdependence of the core financial institutions which are already in a position of authority and intersectional commerce within the Islamic financial community. Unfortunately, as with reporting participation, efforts to create such a global financial exchange have not motivated financial institutions to participate because the exchange structure generally stands independent from day-to-day financial operations of participating banks and financial institutions. Thus, a successful deployment of a global Islamic exchange would draw a direct line between increased efficiencies of daily operations of participating institutions and greater market capabilities and profitability stemming from Islamic exchange functions. This direct line would supporting the ready and efficient sale, purchase or trade of institutional financial obligations or investments, among other things. Participation in the exchange would thereby serve as a tool in aiding the freer flow of capital between institutions and investments, thus bettering market performance and institutional and investor liquidity. A global exchange is necessary for the Islamic financial market to enter its next stage of economic evolution.

What is thus needed is a financial system that will afford Islamic institutions the opportunity to participate in volume Shari'ah compliant investment subscriptions pursuant to standardized financial instruments with greater efficiency. Preferably, such a financial system will provide a means to enable participating institutions to issue and sell financial instruments in support of their own investment functions that can be subscribed on an accelerated basis. Preferably, such a financial system will contribute to the creation of a more liquid Islamic investment marketplace. Preferably, such a financial system will promote the free flow of Islamic investment capital into the institutional capital markets to create the type of market dynamic that is conducive to high-volume, passive, institutional investment. Preferably, such a financial system will provide a commercial vehicle for the global implementation of Shari'ah guidelines and policies as set by certain Islamic supervisory and auditing organizations. Preferably, such a financial system will serve to provide economic motivation to participating financial institutions to cooperate with financial reporting and Shari'ah compliance guidelines consistent with international standards such that a financial rating system specially tailored to the Islamic institution can be manifest therefrom. Preferably, such a financial system will contribute to the development of a centralized global Islamic financial exchange specifically established and catering to the financial needs of the participating Islamic financial institutions and banks.

### SUMMARY OF THE INVENTION

A financial process in accordance with the principles of the present invention will afford Islamic institutions the opportunity to participate in volume Shari'ah compliant investment subscriptions pursuant to standardized financial instruments with greater efficiency. Preferably, a financial process in accordance with the principles of the present invention will provide a means to enable participating institutions to issue and sell financial instruments in support of their own investment functions and liquidity requirements that can be subscribed on an accelerated basis. Preferably, a financial process in accordance with the principles of the present invention will contribute to the creation of a more liquid Islamic investment marketplace. Preferably, a financial process in accordance with the principles of the present invention will promote the free flow of Islamic investment capital into the institutional capital markets to create the type of market dynamic that is conducive to high-volume, passive, institutional investment. Preferably, a financial process in accordance with the principles of the present invention will provide a commercial vehicle for the global implementation of Shari'ah guidelines and policies as set by certain Islamic supervisory and auditing organizations. Preferably, a financial process in accordance with the principles of the present invention will serve to provide economic motivation to participating financial institutions to cooperate with financial reporting and Shari'ah compliance guidelines consistent with international standards such that a financial rating system can be manifest therefrom. Preferably, such a financial system will contribute to the development of a centralized global Islamic financial exchange specifically established and catering to the financial needs of the participating Islamic financial institutions and banks.

An inter-bank network formulated in accordance with the principles of the present invention supports the implementation of certain Shari'ah (Islamic) compliant financial products. A standardized, Shari'ah (Islamic) compliant financial instrument is created which is conducive to trading and which has comparable characteristics to those traded on the conventional markets. An inter-bank alliance is formed under which the participants in the network play multiple and varied financial roles in select financial offerings prior to taking an investment offering to the Islamic investment marketplace for placement. In particular, each participating institution in the inter-bank alliance agrees to support the position of another participating institution as may be required under a contingent guarantee of repurchase in support of such other participating financial institution's issuance of financial instruments. Thus, when the financial instrument is issued, it is underwritten for repurchase via syndication amongst the inter-bank participants via their respective issuance of their repurchase guarantees which are callable on a contingent basis. The issuer also acts as repurchase guarantor on a contingent basis on behalf of another bank in the inter-bank alliance as issuer of their own respective financial instruments.

A financial process in accordance with the principles of the present invention creates a centralized, networked electronic messaging and communications system in support of the establishment of an Islamic inter-institutional/inter-bank alliance. Such a system will encourage financial transactions related to certain financial instruments that are capable of producing greater market efficiencies and liquidity for Islamic financial institutions and investors. A financial process in accordance with the principles of the present invention enables the efficient issuance, underwriting and placement of sanctioned financial instruments amongst networked Islamic financial institutions. A financial process in accordance with the principles of the present invention can be applied to enable the networked issuance and underwriting of Shari'ah compliant passive financial instruments for the purposes of promoting and facilitating the efficient sale and/or placement of equity and/or debt in support of certain projects, ventures, investments and/or investment funds.

Particularly, in one embodiment a financial process in accordance with the principles of the present invention will coordinate a central infrastructure to the inter-workings of Islamic financial institutional investment practices. A standardized financial processes model is provided over which financial and banking transactions can be accommodated electronically with due homage given to the necessity for Shari'ah compliant practices to guide baseline operations. The financial process can include an electronic messaging and communications system in support of the establishment of an Islamic inter-institutional/inter-bank alliance. The process model, via a well-engineered network of computer-based communications, administrative practices and settlement models, can coordinate a central infrastructure to the inter-workings of Islamic financial institutional investment practices. Participating Islamic institutions, institutional investors, banks and financial institutions will take part in electronically tracking and detailing investment proceeds from origination through to deployment into individual subject investments or institutions. An electronic data base which details funds providence, financial performance of both individual underlying investments and Investment Units, and matters pertaining to Shari'ah compliance decisions will result. The system will contribute to the development of a centralized global Islamic financial exchange specifically established and catering to the financial needs of the participating Islamic financial institutions and banks.

A financial process in accordance with the principles of the present invention bridges the religious, cultural and investment processing “gap” between conventional market processes and Islamic investment requirements. A financial process in accordance with the principles of the present invention makes the adaptation of international financial reporting standards by Islamic financial institutions reasonable, economical, beneficial and efficient while allowing for Shari'ah compliance and related governance issues to be concurrently reflected and reported in the process. A financial process in accordance with the principles of the present invention fosters the creation of a financial rating system for the Islamic financial market that allows for an efficient evaluation of an investment opportunity or institution on the merits of both financial standing and Shari'ah compliance, making performance in the Islamic financial market measurable in a manner consistent with generally accepted investment practices as is customary via the use of conventional market credit rating mechanisms. Specifically, the present invention creates a standardized platform for the regularized performance evaluation of a subject Shari'ah compliant project, investment or find in keeping with conventional economic norms such that high-volume, passive to semi-passive institutional investment may be cultivated and promoted within the international Islamic investment community. The successful networked implementation of the present invention will bring to the Islamic investment community the ability to place full reliance upon impartial and recognized entities for the purposes of both financial evaluation and on-going Shari'ah compliance of the investment or institution, thereby affording the Islamic investor with the fiscal luxury of necessarily conducting only a cursory review of each investment structured in accord with the principles of the present invention.

A financial process in accordance with the principles of the present invention promotes greater investment liquidity for Islamic investors and financial institutions via the fostering of institutional investment using a consistently formatted financial instrument which is conducive to the development of a secondary market, thus promoting the freer flow of Islamic investment capital into the institutional capital markets. A financial process in accordance with the principles of the present invention will foster the development of an Islamic securities exchange in which the participating institutions will play a key role as registered exchange members. In short, it provides for the creation of a far more manageable and efficient Islamic investment function and inter-institutional banking, financial and investment functions than present practices permit.

### BRIEF DESCRIPTION OF THE DRAWINGS

FIG. 1 schematically shows the inter-bank lending practices of the conventional markets of the prior art.

FIG. 2 shows a schematic overview of a financial process in accordance with the present invention.

FIG. 3 is a schematic overview of a preferred embodiment of a wide area network implementation of the subscription process of the financial processes of FIG. 2 in accordance with the principles of the present invention.

FIG. 4 is a schematic overview of a preferred embodiment of a wide area network implementation of the monitoring and reporting of investments of the financial processes of FIG. 2 in accordance with the principles of the present invention.

FIG. 5 is a schematic overview of a preferred embodiment of a wide area network implementation of the dividend distribution of the financial processes of FIG. 2 in accordance with the principles of the present invention.

FIG. 6 is a schematic overview of a preferred embodiment of a wide area network implementation of the financial instrument repurchase of the financial processes of FIG. 2 in accordance with the principles of the present invention.

### DETAILED DESCRIPTION OF THE INVENTION

A financial process in accordance with the principles of the present invention is designed to provide an inter-institutional/inter-bank networked methodology in support of the implementation of certain Shari'ah (Islamic) compliant financial products. A financial process in accordance with the principles of the present invention is designed to provide a networked integration of the principles, practices and actions to support such Shari'ah (Islamic) compliant financial products. In the preferred embodiment described herein, the passive, investment-grade, Shari'ah compliant investment unit utilized is described in U.S. patent application Ser. No. 10/295,087 titled “Investment Grade Shari'ah (Islamic) Compliant Financial Products” filed 15 Nov. 2002 and previously defined as the “Investment Unit”. It should be understood, however that the principles of the present invention apply to other financial instruments as well.

By nature the financial instruments are positioned to assure a minimum value repurchase of the financial instruments at their term or such other date as financial instruments may be permitted for repurchase. This guaranteed repurchase value is enabled by the enhancement of one institution with the credit-worthy “undertaking to repurchase” issued by another allied institution. In the conventional markets, this type of process is undertaken regularly via traditional credit enhancement mechanisms or securitizations; however, under Shari'ah law as specifically applicable to financial practices, there are three key considerations to enabling a comparable functionality.

First, an issuer of any obligation or security, whether debt or equity, may not be guaranteed for minimum value by the issuer itself, therefore any such minimum assurances or risk management mechanisms must be afforded by a third party institution. This restriction virtually eliminates the means by which conventional market wisdom operates in assuring value or repayment related to a security, as the case may be.

Second, although a third party guarantor may be introduced in conventional circles to enhance a transaction or security if the issuer is unable or unwilling to do so, under Shari'ah law, that guarantor may not be paid any consideration for its financial undertaking or assumption of risk. Such a restriction disposes of the most apparent fiscal motivation for issuance of such a guarantee or for a guarantor's participation in a transaction of this type. Thus, to proceed in a Shari'ah compliant manner, some alternate inventive must be present to make the assumption of this role palatable.

Third, in the event that a guarantor is persuaded and does agree to issue the required guarantee without such consideration, the guarantor is not permitted to take collateral, security or any other form of control over the investment to which the proceeds which are enabled by its guarantee are applied. A violation of any of these provisions creates a basis by which the transaction would not likely be permissible under Shari'ah investment and financial guidelines. It is on this basis that what is proposed by the present invention is a radical departure from what has been historically achievable within the context of Shari'ah financial guidelines.

In order to create a consistent model that will sufficiently motivate participation of candidate guarantors, the present invention provides for an inter-institutional alliance whereby each participating institution will agree to support the position of another as may be required under the aforementioned guarantee mechanism. The undertaking to participate in this cross-guarantee structure by an institution assures that particular participating institution that when it elects to go to the capital markets to place an issuance of its own, it will be supported in its issuance by other participating banks in the inter-institutional alliance via the issuance of their respective repurchase guarantees. This creates an inter-related banking or financial system in which each institution, respectively, is vested in the financial interests and performance of the other institutions.

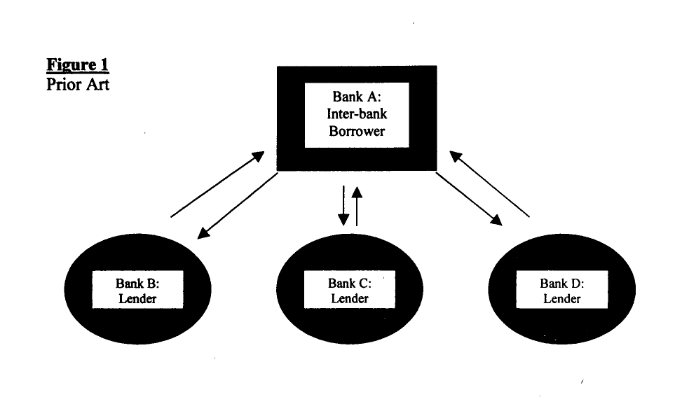

An inter-bank alliance amongst Islamic financial institutions in accordance with the present invention has a comparably favorable impact upon the participating banks just as traditional inter-bank lending practices do in the conventional market sector. Conventional market practices in this regard are quite simple and straightforward in yielding liquidity to participating banks. Referring to FIG. 1, for example, the inter-bank lending practices of the conventional markets permit a very direct, practical and fiscally streamlined approach to the role of participating banks; one bank that requires credit stands singularly as a member of an inter-bank affiliation, making a request for credit. One or more banks from that affiliation agree to lend required funds in exchange for certain debt-based consideration from the borrowing institution. The function is linear in approach—borrower to lender(s)—with the primary interest in lending by the banks in the affiliation being some form of financial gratification.

Likewise, this same model applies to a conventional financial institution's approach to the capital markets as the basis to offer a security in order to raise finds; the issuing institution issues its security with its good credit rating standing behind the obligation and the security is sold, yielding proceeds to the issuer. The good rating of the instrument in the market then becomes the basis by which the security may be traded and/or resold by investors, assuring a degree of investment liquidity in the marketplace.

At its simplest level within the context of the conventional markets, a financial institution issues a standard format security or instrument that is backed by the “full faith and credit” of a known issuer or guarantor (as rated by Standard & Poor's, 55 Water Street, New York, N.Y. 10041 (“S&P”), Moody's Investors Service, Inc., 99 Church Street, New York, N.Y. 10007 (“Moody's”) or some other comparable credit rating agency, for example). This rating fosters a trading friendly, liquid market. It is this component, among related ancillary issues, which is lacking within the context of a Shari'ah compliant capital marketplace such that investment liquidity is inconsistent and unpredictable. In other words, since conventional inter-bank lending is fundamentally inconsistent with Shari'ah financial practices, the present invention creates a means in which the basic tenets of Shari'ah financial principles are observed within a framework of standardized administrative processes which are conducive to the issuance of investment grade financial instruments.

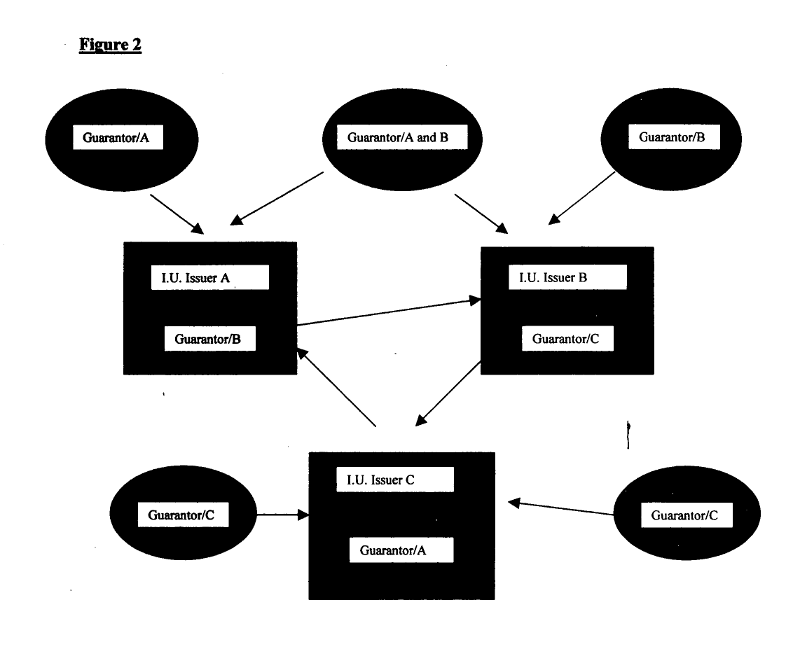

Referring to FIG. 2, a schematic overview of a financial process in accordance with the present invention is seen. The financial process of the present invention creates an environment in which third party financial institutions can be motivated by means outside the scope of direct consideration or collateralization to engage in tendering their respective fiscal strength. This fiscal strength is tendered in the form of a contingent guarantee of repurchase in support of a participating financial institution's issuance of its financial instrument. This may be accomplished via a multi-triangulated approach to the marketplace in which a network of guarantors and issuers come together to issue, underwrite, and guarantee suitable investment grade securities (per conventional market standards). The participants in the network play multiple and varied financial roles in select financial offerings prior to taking an investment offering to the Islamic investment marketplace for placement.

This inter-connected network of participating Islamic financial institutions will produce a standardized financial instrument which is conducive to trading and which has comparable characteristics to those traded on the conventional markets, thus breeding market liquidity. Moreover, inter-bank ties will be inherently strengthened due to the playing of multiple offsetting roles between a variety of participating institutions, thereby producing greater operating stability in the inter-bank alliance itself. For example, a participating Islamic financial institution will organize a financial instrument issuance subscribing to the endorsed format adopted by the inter-bank alliance. It will be underwritten for repurchase via a syndication amongst the inter-bank alliance participants via their respective issuance of their repurchase guarantee(s) (a standby letter of credit or like instruments) which are callable on a contingent basis. The issuer then takes the financial instruments which have one or more repurchase guarantees associated with them to the open capital markets, making the financial instruments available for investment by Islamic investors, preferably, and draws subscribers' funds therefrom, completing the capitalization triangle.

In parallel to this basic process, however, the issuer in our initial equation is also acting as repurchase guarantor on a contingent basis on behalf of another bank in the inter-bank alliance as issuer of their respective financial instruments. This duality of roles is propagated throughout the participating institutions in the inter-bank alliance, such that the reward for the diversified assumption of risk on behalf of a variety of other participating institutions by each participant is reaped in the ability for each institution to issue financial instruments in support of its operations and investment operations. When administered for risk and equitability of participation under the processes of the present invention, risk is assumed prudently amongst the inter-bank alliance participants on issuances such that a dynamic is created in which any given failure of a financial instrument can be absorbed and offset by the whole of the inter-bank system. Ultimately, this will create a pool of investment and market liquidity amongst the inter-bank participants that is funded by the Islamic institutional financial markets as the subscriber base. The liquid nature of the market for inter-bank originated securities is inevitable as the secondary market, indexing, and exchange services are initiated as ancillary service groups stemming from the core service functions provided to the inter-bank alliance members.

Implementation of the present invention instigates a collective fiscal thought-process amongst participating Islamic financial institutions that furthers the most admirable attributes of Shari'ah thought as such applies to social responsibility against a backdrop of financial functionality. The networked cross-guarantee structure of the inter-bank alliance participants will fuel a healthy interest in allied institutions' performance such that the whole of the inter-bank alliance remains stable and performing properly in the interests of each individual bank. The present invention thus introduces into the Islamic market dynamic an element of collective self-interest which does not currently exist widely within and amongst Islamic financial practices. It is this dynamic that will fuel additional advancements of the Islamic financial market arising from the core of the inter-bank alliance, not the least of which will be a willingness to participate in financial reporting and disclosure requirements in evidence of individual participating financial institution's good-standing. In short, the present investment motivates participating Islamic financial institutions to be inclined to helpfully monitor the activities of their brother banks and likewise to be inclined to openly represent their own financial standing for review by allied institutions.

The need for the fiscal cooperation of allied financial institutions is a tried-and-true means to inspire prudence in investment and compliance in reporting amongst financial institutions in the conventional market. The rating of a conventional institution's performance is the most common means of denoting a performance-based “snapshot” such that the rated institution will be quickly recognized for consistent and reliable performance among other banks. A good responsible representation of management, administrative, and fiscal practices by an institution: broadens the financial capability and depth of the reporting institution; increases bank ratings; makes available facilities more easily and readily accessible; and results in investment programs and issuances being well received in the market.

The financial processes required under the present invention support such a reporting infrastructure within the context of a Shari'ah compliant framework. On a first-hand, daily, and meaningful basis, the financial processes of the present invention support a need for the Islamic financial institution to voluntarily bring forward statements of financial conditions which are consistent with international standards, coupled with statements evidencing the Shari'ah compliant status of investment activities and operations. Based upon the tendering of these reports and disclosures, a clear, beneficial product of the financial processes in accordance with the present invention will permit the administrative body of the inter-bank alliance to render financial ratings of each participating institution by utilizing proven capital markets philosophies and rating criteria, coupled with specially designed rating mechanisms that pertain to matters of Shari'ah law and compliance therewith.

A financial process in accordance with the principles of the present invention encompasses a variety of features that when brought together create a functional model that addresses and improves upon many of the issues raised in the previous discussion. Among other things, a financial process in accordance with the principles of the present invention evidences several peripheral features and benefits which help solve a number of the technical complexities of creating an Islamic financial market with services that the conventional markets have enjoyed for decades. Specifically, the financial process of the present invention creates a centralized, networked electronic messaging and communications system in support of an Islamic inter-institutional/inter-bank alliance. This will encourage financial transactions related to financial instruments that are capable of producing greater market efficiencies and liquidity for Islamic financial institutions and investors. The financial process of the present invention enables the efficient issuance, underwriting, placement and repurchase of sanctioned financial instruments amongst networked Islamic financial institutions. The financial process of the present invention supports the active deployment of certain Shari'ah compliant financial instruments that are uniformly formatted amongst themselves such that a standardized security or financial instrument is created. This financial instrument need not materially vary based upon the underlying intended use of proceeds derived from the sale or placement of the financial instrument to the Islamic investor. The financial processes of the present invention raises investment efficiencies and creates a foundation in the marketplace which is by nature conducive to the valuation and remarketing of sanctioned financial instruments, and thereby assures a degree of liquidity of the investment to the investor. The financial process of the present invention enables the retention of a minimum anticipated value of certain sanctioned financial instruments at the conclusion of the investment term, thus contributing to the ratable nature of the financial instruments and the evolution of an Islamic trading market therefore and for other sanctioned securities. The financial process of the present invention serves as a motivating factor in inducing the adoption of an international financial reporting and disclosure standard by participating Islamic financial institutions such that participating financial institutions can qualify for continuing financial participation in sanctioned products.

By way of creating a comprehensive general financial rating system founded upon certain standardized financial and Shari'ah compliance criteria, the present invention enables financial institutions and associated financial instruments to be readily evaluated and graded against financial reporting and disclosure data provided, such that there is greater ease in investor, institutional and market assessment, thereby increasing the overall efficiency and productivity of the Islamic investment market. Additionally, by way of the deployment of specific computer-based inter-bank processes, the present invention can constitute an operating template for the creation of a unified Islamic financial services market which is an operating extension of policies and supervisory guidelines that are set forth by institutions such as the IFSB and AAOIFI.

The foregoing features demonstrate a clear and distinct need for a financial process in accordance with the principles of the present invention to help centralize and standardize inter-bank relations within the Islamic financial market. Such a standardization of the Islamic financial market will create an investment climate for the Islamic investor with greater investment liquidity, more clear-cut financial disclosures and reliable data, and more standardized financial instruments in which to invest. As for the banking environment, the present invention will induce more open financial disclosures and reporting amongst financial institutions, provide more coordinated cross-border inter-bank policies and systems, identify more measurable areas of specific risk related to the issuance of financial instruments, and provide greater continuity and efficiency in tracking start-to-finish investment performance and Shari'ah compliance between the financial institutions, the investors, and the underlying investments. In all of the above examples, the common denominator is one of standardization and consistency in a Shari'ah (Islamic) compliant inter-bank networked investment structure which fosters a regularization of the Islamic financial marketplace.

For the purposes of explanation and not to narrow the scope of the present invention, the following describes an example of a financial instrument in accordance with the principles of the present invention.

### EXAMPLE

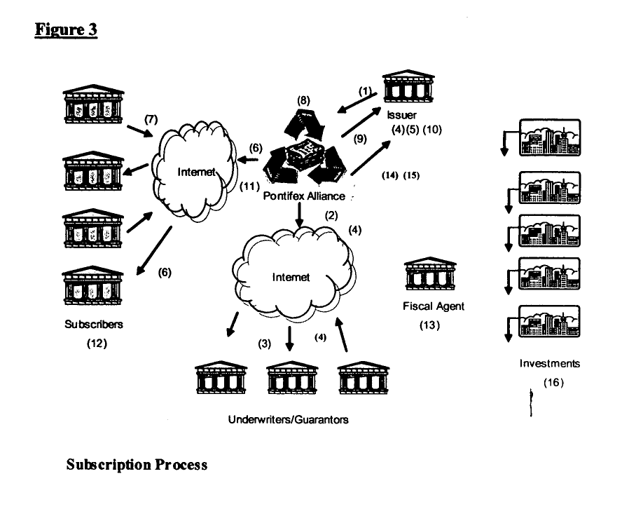

Referring to FIGS. 3-6, a preferred embodiment of a wide area network implementation of a financial process in accordance with the principles of the present invention is seen. In a preferred embodiment, the wide area network is the Internet. In one embodiment, the system can be comprised of two major elements: a web browser and a web server. The web browser is platform (e.g. Sparc™, Risc, x86, etc.) independent and operates on any software capable of displaying HyperText Markup Language (HTML) files such as Internet Explorer from Microsoft Corporation of Redmond, Wash. or Netscape Communicator from Netscape Communications Corporation of Mountain View, Calif. The web server may be hosted on a network of Intel-based server systems available from Intel Corporation of Santa Clara, Calif. running on a Microsoft Windows NT Server operating system available from Microsoft Corporation using Enterprise Webserver software from Netscape Communications Corporation. Each of these components may be hosted on separate machines, each of which may be a component of a server farm. Alternative computer systems consisting of one or more computers employing different forms of operating systems and application systems may be used to host the system of the present invention.

Referring to FIG. 3, a preferred embodiment of a wide area network implementation of the subscription process of the financial instrument in accordance with the principles of the present invention is seen. Initially, the Issuer assembles all documentation in support of an Offering of a series of Investment Units, inclusive of a Subscription Agreement and Offering Memorandum which include information as to targeted performance of the proposed Investments and permitted Investments under the Investment Unit Series (1). The Offering documentation is then distributed via a secure web access service to potential entities within the inter-bank alliance that would to be willing assume a role as Underwriter/Guarantor of Investment Unit repurchase at the conclusion of the Investment Term (2).

One or more Financial Institutions, as proposed Underwriter/Guarantors, bid to Guarantee the repurchase of all or a portion of the Investment Unit Series (3). Guarantee Bids are received from one or more proposed Underwriters/Guarantors, the qualifications of such proposed Underwriters/Guarantors to act in such capacity are checked against a database, and, provided such schedule of proposed Underwriter/Guarantors meets with minimum requirements either with or without modification or adjustment, this schedule is passed on to the Issuer for review and approval (4). If a sufficient value of proposed Guarantees is not bid on and received, the Issuer will potentially decrease the total Investment Unit Series value or otherwise adjust the scheduled issuance such that the Offering may proceed.

The Issuer approves the schedule of proposed Underwriter/Guarantors, and the Offering becomes available for subscription by qualified Subscribers/Investors (5). Offering documentation and information is delivered to potential Subscribers/Investors that are duly licensed Financial Institutions and such other qualified institutional investors that are authorized members (6). Subscribers/Investors submit their subscription bid, inclusive of an electronic version of their fully executed Subscription Agreement, covering all or a portion of the Investment Units Series (7). Subscribers/Investors are not guaranteed to get any or all of the requested Investment Units being offered, but are making application for subscription subject to acceptance by the Issuer.

The subscription bids are received (8). The system calculates the total proposed amount of subscription from each potential subscriber by taking into account certain minimum qualifications for subscription, previous participation in scheduled Offerings, good standing as an inter-bank alliance (or related exchange) member, reporting and compliance criteria, and other factors to make a final allocation of the Subscriber participation. The final subscription allocations are then reported to the Issuer for final approval (9). Issuer reports any proposed Subscribers/Investors that it finds objectionable (10). Required changes are made to the subscription allocation, if needed, and the final subscription allocation is reported to the Subscribers/Investors, instructing them to deliver funds to the Fiscal Agent per the terms of the Subscription Agreement (11). Subscribers/Investors transfer funds to the Fiscal Agent (12). While in a preferred embodiment the reporting of this transaction occurs within the system, the actual funds transfer occurs outside of the system. Funds are received by the Fiscal Agent in its designated Holding Account where final compliance on Subscription Proceeds is performed, and the receipt of funds is reported (13). A request is generated for payment of any applicable placement fees and charges due as associated with the subscription, delivering such to Issuer. Again, while in a preferred embodiment the reporting of this transaction occurs within the system, the actual funds transfer occurs outside of the system (14).

The Issuer remits applicable payments against receipt of payment request/invoice (15). Investment Unit proceeds are fully and freely available to Issuer for investment into qualified Shari'ah compliant Investments pursuant to the permitted fund uses identified in the Offering documentation (16). Again, while in a preferred embodiment the reporting of this transaction occurs within the system, the actual funds transfer occurs outside of the system.

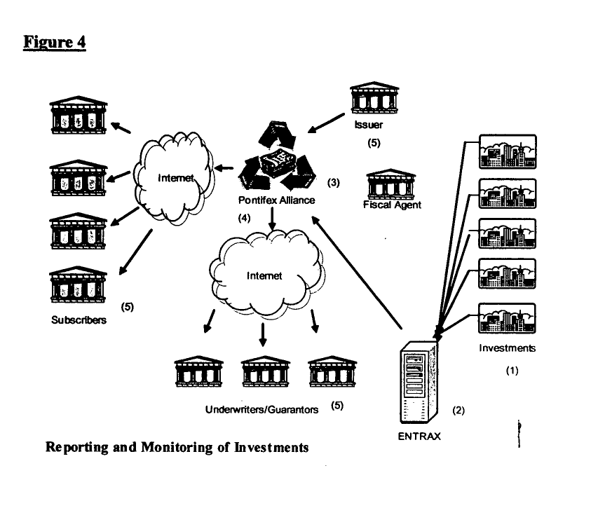

Referring now to FIG. 4, a schematic overview of a preferred embodiment of a wide area network implementation of the monitoring and reporting of investments of the financial process in accordance with the principles of the present invention is seen. In a preferred embodiment, this system is contained on a computer system separate from the system that contains the subscription process of the financial instrument of the present invention. Initially, each Investment will be required to report certain information, inclusive of financial and Shari'ah compliance data, via a system that will gather and standardize the data for use in monitoring the financial health of the Investment and its on-going Shari'ah compliance (1). The monitoring and reporting system will receive the information in a standardized web-based form and prepare periodic reports, such as for example monthly or quarterly reports, as the case may be, on each respective Investment's data (2). The Investment/reporting data is passed to the subscription system through a secure web connection in an xml (Extensible Markup Language) format (3).

The Investment/reporting data is used by the subscription system to calculate and track the financial health and Shari'ah compliance of each Investment arising from the proceeds of an offering of Investment Units (4). Periodic reports are delivered to all relevant participants, inclusive of Issuer of the Investment Unit Series which supported the Investment, Subscribers/Investors to the Investment Unit Series which supported the Investment, Underwriters/Guarantors that have underwritten the repurchase of the Investment Units at term, and upon permitted inquiry other registered or qualified interested parties (governmental, AAOIFI, IFSB, etc.) (5).

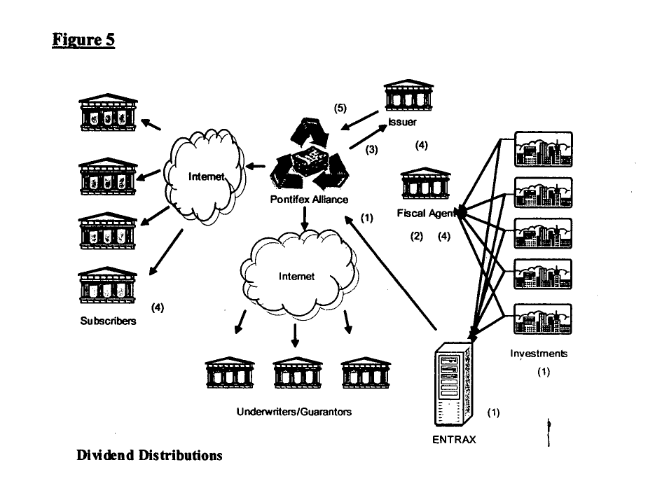

Referring now to FIG. 5, a schematic overview of a preferred embodiment of a wide area network implementation of the dividend distribution financial process in accordance with the principles of the present invention is seen. Dividends are declared and distributed by the Investment pursuant to their respective investment agreements with Issuer (1). Dividends payable are reported to the subscription system through monitoring and reporting system, although the dividends are distributed to the Issuer via the Fiscal Agent. While in a preferred embodiment the reporting of this transaction occurs within the system, the actual funds transfer occurs outside of the system.

Dividends are received into the designated account of the Fiscal Agent (2). The Dividend data received from the monitoring and reporting system is utilized to generate a request for payment of any applicable fees and charges due (3). The Fiscal Agent distributes Dividends to Subscribers/Investors and Issuer per the terms of the Fiscal Agency Agreement (4). Again, while in a preferred embodiment the reporting of this transaction occurs within the system, the actual funds transfer occurs outside of the system.

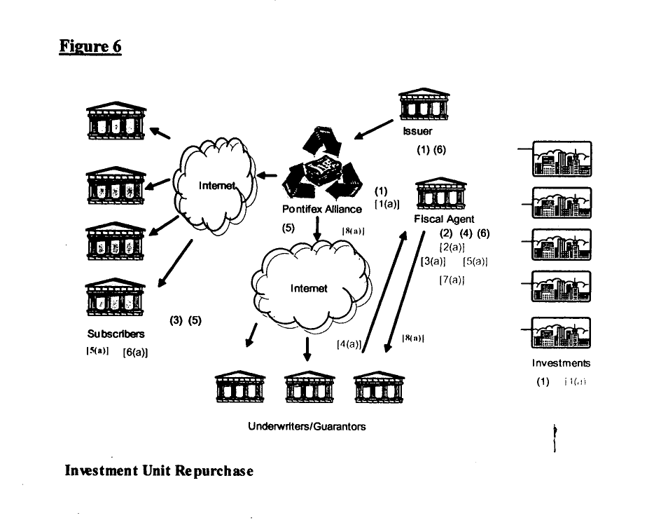

Referring now to FIG. 6, a schematic overview of a preferred embodiment of a wide area network implementation of the investment unit repurchase of the financial process in accordance with the principles of the present invention is seen. Initially, a determination is made whether the Investment portfolio is of sufficient value to cover all costs associated with scheduled Investment Unit repurchase. If it is, then pursuant to the terms of investment, the Investments, respectively, and the Issuer, if necessary or otherwise required, remit funds in favour of the Issuer via the Fiscal Agent prior to the scheduled repurchase date of the Investment Units (1). While in a preferred embodiment the reporting of this transaction occurs within the system, the actual funds transfer occurs outside of the system. The Fiscal Agent consolidates amounts received from Investments and the Issuer, if so required, such that the full value of the Investment Unit Series is supported for repurchase, and notifies the Subscribers/Investors of the scheduled repurchase of outstanding Investment Units in the Series, inclusive of providing instruction for the surrender of Investment Units to Fiscal Agent or its nominee (2). The Subscribers/Investors surrender Investment Units to Fiscal Agent per instructions received (3).

The Fiscal Agent repurchases the subscription from the Subscribers/Investors for an amount equal to the Investment Units par value at time of original subscription and distributes any final dividends payable as may have been declared and outstanding related to the Investment Units (4). The Subscribers/Investors receive full settlement from the Fiscal Agent for Investment Units repurchased. Again, while in a preferred embodiment the reporting of this transaction occurs within the system, the actual funds transfer occurs outside of the system (5). Fiscal Agent disposes of repurchased Investment Units pursuant to Issuer's instruction (6).

If the Investment portfolio when taken together with Issuer's dedicated and available reserves is not of sufficient value to cover the full cost of repurchase as scheduled with the Fiscal Agent, a different process occurs. Pursuant to the terms of investment, the Investments, respectively, and the Issuer, if necessary or otherwise required, remit funds in favour of the Issuer via the Fiscal Agent prior to the scheduled repurchase date of the Investment Units (1a). While in a preferred embodiment the reporting of this transaction occurs within the system, the actual funds transfer occurs outside of the system. The Fiscal Agent consolidates amounts received from Investments and the Issuer, if so required, such that the maximum value of available funds to be applied toward repurchase is held on Fiscal Agent's designated account, and Fiscal Agent notifies the Subscribers/Investors of the shortfall on the scheduled repurchase value of outstanding Investment Units (2a). Pursuant to the terms of the Fiscal Agency Agreement, against Subscriber's acknowledgement, the Fiscal Agent draws upon the Guarantees issued by the Guarantors and held by the Fiscal Agent in order to cover the repurchase shortfall or deficit (3a).

The Fiscal Agent will draw the same pro-rata share of each outstanding guaranty to offset the shortfall, such that each draw is equal to each Guarantor's respective Guarantee percentage, unless otherwise agreed. Pursuant to the terms of the Guarantees, Guarantors remit the amounts drawn to the Fiscal Agent (4a). Fiscal Agent receives respective Guarantee payments, consolidates these funds with those already on deposit in support of Investment Unit repurchase and notifies the Subscribers/Investors of scheduled repurchase, instructing the surrender of all Investment Units to be so repurchased (5a). Subscribers/Investors surrender the Investment Units to Fiscal Agent (6a). The Fiscal Agent repurchases outstanding Investment Units from Subscribers/Investors, and Subscribers/Investors receive full settlement for value equal to the par value thereof (7a). While in a preferred embodiment the reporting of this transaction occurs within the system, the actual funds transfer occurs outside of the system. The Fiscal Agent disposes of or delivers repurchased Investment Units pursuant to Guarantor's instruction (8a). Again, while in a preferred embodiment the reporting of this transaction occurs within the system, the actual funds transfer occurs outside of the system. The reporting for each step of the above is the same as documented on the reporting of dividends.

While the invention has been described with specific embodiments, other alternatives, modifications and variations will be apparent to those skilled in the art. Accordingly, it will be intended to include all such alternatives, modifications and variations set forth within the spirit and scope of the appended claims.

The following Glossary of Terms is set forth for convenience and should not be construed as limiting the scope of the present invention:

Glossary of Terms

Auditing and Accounting Office of Islamic Financial Institutions (“AAOIFI”): responsible for, among other things, the monitoring and oversight of Islamic banking and investment institutions.

Auditor: The firm to be appointed should specialize in matters of Islamic finance. It should afford the Issuer with a comprehensive and Shari'ah compliant accounting body upon which the Shari'ah Supervisory Board and the investors may place reliance.

Fiscal Agent: a substantial international banking institution having a credit agency rating of sufficient quality to meet minimal rating criteria set forth by the nominated credit rating agency which rates the Investment Units; acts as the administrator for the issuance of the Investment Units, paying agent on behalf of the Issuer in favour of the Investors, and agrees and administers Investment Unit repurchase.

Guarantee: the letter of credit, preferably a standby letter of credit, which is issued by the Underwriter/Guarantor in support of the repurchase of the Investment Units.

Holding Account: a non-interest bearing, depository account at the Fiscal Agent's institution designated for the receipt of proposed Subscription Proceeds prior to the Subscriber/Investor having been accepted by the Issuer for purchase of the Investment Units.

Inter-bank Alliance: the networked processes which embody or otherwise constitute the present invention.

Investment: the project or company which is, was or became the intended application or use of the proceeds derived from the sale of the Investment Units.

Investment Term: the term of the Investment Units, or that period between the date of subscription and the scheduled date of redemption of the Investment Units.

Investment Unit: a Shari'ah (Islamic) compliant passive investment grade investment vehicle that is the subject of U.S. patent application Ser. No. 10/295,087 titled “Investment Grade Shari'ah (Islamic) Compliant Financial Products” filed 15 Nov. 2002, the disclosure of which is incorporated herein by this reference).

Issuer: the entity which issues the Investment Units, makes the Offering for the purpose of attracting investment and subsequently manages and implements the proceeds of the sale of the Investment Units in a manner consistent with the investment criteria established related to that certain Offering for which the Investment Units were issued.

Member bank or institution: a participating institution within the Inter-bank Alliance.

Offering: the means by which the Investment Units are made available for purchase to the investment marketplace.

Offering Memorandum: the document which provides the potential investor with a required description of and disclosure related to the nature of the Investment Units being offered for sale.

Rating Agency: Moody's Investor Services, Standard & Poors, or such other internationally recognized credit rating agency.

Subscribers/Investors: those entities, parties or individuals who purchase the Investment Units, consisting of Islamic institutional investors (primarily banking and financial institutions), Islamic investment management funds, high net worth Islamic individuals and trusts and, to a lesser extent, non-Islamic investors.

Subscription Agreement: the agreement which defines the terms and conditions of the subscription of and investment in the Investment Units by the Subscriber/Investor.

Subscription Proceeds: the funds denominated in United States Dollars which were derived from the sale of the Investment Units to the Subscribers/Investors.

Underwriter/Guarantor: This entity may consist of several international banking institutions, or functionally comparable entities; however, in general there is a lead underwriting institution of sufficient credit quality (its credit rating according to S & P or Moody's) to meet minimal rating criteria set forth by the nominated credit rating agency which subsequently rates the Investment Units. The Underwriter/Guarantor is engaged for the purposes of issuance of its guarantee in support of the repurchase of the Investment Units at the close of the Investment Term.

What is claimed is:

1. A computer automated subscription process of a financial instrument comprising:
assembling a subscription agreement and an offering memorandum for investment units;
electronically distributing the documentation to potential entities that would to be willing assume a role as underwriter/guarantor of investment unit repurchase;
receiving bids from one or more institutions to guarantee the repurchase of all or a portion of the investment units;
inducing the guarantee under a Shari'ah compliant framework;
making the investment units available for subscription by qualified subscribers;
receiving bids for subscription bids;
allocating investment units to subscribers.

2. The computer automated subscription process of a financial instrument of claim 1 further including distributing the documentation via a secure web access service.

3. The computer automated subscription process of a financial instrument of claim 1 further including checking the qualifications of proposed underwriters/guarantors to act in such capacity against a database.

4. The computer automated subscription process of a financial instrument of claim 3 further including, provided such proposed underwriter/guarantors meet with the qualifications, approving the proposed underwriter/guarantors.

5. The computer automated subscription process of a financial instrument of claim 1 further including, if a sufficient value of proposed guarantees is not bid on and received, decreasing the investment units value.

6. The computer automated subscription process of a financial instrument of claim 1 further including, if a sufficient value of proposed guarantees is not bid on and received, adjusting the scheduled issuance.

7. The computer automated subscription process of a financial instrument of claim 1 further including calculating the total proposed amount of subscription from each potential subscriber by taking into account qualifications selected from the group comprising previous participation in scheduled offerings, good standing as a member, reporting and compliance criteria, and combinations thereof.

8. The computer automated subscription process of a financial instrument of claim 1 further including subscribers transferring funds to a fiscal agent in a designated holding account where compliance on subscription proceeds is performed.

9. The computer automated subscription process of a financial instrument of claim 1 further wherein the step of inducing the guarantee under a Shari'ah compliant framework comprises no direct consideration for the guarantor.

10. The computer automated subscription process of a financial instrument of claim 1 further wherein the step of inducing the guarantee under a Shari'ah compliant framework comprises no security for the guarantor.

11. A computer automated monitoring and reporting of a financial instrument comprising:
receiving from subscribers financial and Shari'ah compliance information;
calculating and tracking the compliance of each investment arising from the proceeds of an offering of investment units.

12. The computer automated monitoring and reporting process of a financial instrument of claim 11 further including passing information through a secure web connection.

13. The computer automated monitoring and reporting process of a financial instrument of claim 11 further including receiving the information in a standardized web-based form.

14. The computer automated monitoring and reporting process of a financial instrument of claim 11 further including preparing periodic reports on investment information.

15. A computer automated dividend distribution process of a financial instrument comprising:
declaring dividends;
sending the dividends into a designated account of a fiscal agent;
distributing dividends to the issuer via the fiscal agent.

16. A computer automated repurchase process of a financial instrument comprising:
determining whether the portfolio is of sufficient value to cover costs associated with a scheduled investment unit repurchase;
if the portfolio is of sufficient value to cover costs associated with a scheduled investment unit repurchase, remitting funds in favour of an issuer via a fiscal agent prior to the scheduled repurchase date of investment units;
consolidating amounts received from investments and the issuer such that the full value of the investment units may be repurchased;
notifying subscribers of the scheduled repurchase of outstanding investment units;
the subscribers surrendering investment units to fiscal agent; and
repurchasing the subscription from the subscribers.

17. The computer automated repurchase process of a financial instrument of claim 16 further including repurchasing the subscription from the subscribers for an amount equal to the investment units par value at time of original subscription.

18. The computer automated repurchase process of a financial instrument of claim 16 further including distributing any final dividends payable as may have been declared and outstanding related to the investment units.

19. A computer automated repurchase process of a financial instrument comprising:
determining whether the portfolio is of sufficient value to cover costs associated with a scheduled investment unit repurchase;
if the portfolio is not of sufficient value to cover costs associated with a scheduled investment unit repurchase, remitting finds in favour of an issuer via a fiscal agent prior to the scheduled repurchase date of investment units;
consolidating the amounts received;
notifying subscribers of the shortfall on scheduled repurchase of outstanding investment units;
drawing upon a guarantee in order to cover the repurchase shortfall;
paying subscribers full settlement for value equal to the par value thereof.

20. The computer automated repurchase process of a financial instrument of claim 19 further including drawing a pro-rata share of each outstanding guaranty to offset the shortfall.

21. The computer automated repurchase process of a financial instrument of claim 19 further including consolidating guarantee payments with those already on deposit in support of investment unit repurchase and notifying subscribers of scheduled repurchase.

22. The computer automated repurchase process of a financial instrument of claim 19 further including disposing of or delivers repurchased investment units pursuant to guarantor's instruction.

23. An inter-financial institutional network to support of the implementation of certain Shari'ah (Islamic) compliant financial products comprising:
creating a standardized, Shari'ah (Islamic) compliant financial instrument which is conducive to trading and which has comparable characteristics to those traded on the conventional markets;
forming an inter-financial institutional alliance whereunder the participants in the network play multiple and varied financial roles in select financial offerings prior to taking an investment offering to the Islamic investment marketplace for placement;
each participating institution in the inter-financial institutional alliance agreeing to support the position of another participating institution as may be required under a contingent guarantee of repurchase in support of such other participating financial institution's issuance of financial instruments;
underwriting for repurchase via a syndication amongst the inter-financial institution participants via their respective issuance of their repurchase guarantee which are callable on a contingent basis;
taking the financial instruments to the open capital markets and draws subscribers/funds therefrom; and
the issuer also acting as repurchase guarantor on a contingent basis on behalf of another bank in the inter-bank alliance as issuer of their respective financial instruments.
